(19) United States
(12) Patent Application Publication
(10) Pub. No.: US 2012/0300595 A1
(43) Pub. Date: Nov. 29, 2012

(54) MOTOR DRIVE DEVICE AND ANALOGUE ELECTRONIC TIMEPIECE

(76) Inventors: Shotaro KAMIYAMA, Chiba-shi (JP); Akira Takakura, Chiba-shi (JP); Saburo Manaka, Chiba-shi (JP); Hiroshi Shimizu, Chiba-shi (JP); Keishi Honmura, Chiba-shi (JP); Kosuke Yamamoto, Chiba-shi (JP); Kazumi Sakumoto, Chiba-shi (JP); Kenji Ogasawara, Chiba-shi (JP)

(21) Appl. No.: 13/473,834

(22) Filed: May 17, 2012

(30) Foreign Application Priority Data
May 19, 2011 (JP) 2011-112813
Feb. 10, 2012 (JP) 2012-027693

(51) Int. Cl. H02P 8/12; G04B 19/04

(52) U.S. Cl. 368/80; 318/696

(57) ABSTRACT

A secondary cell supplies drive power to a motor of an analogue electronic timepiece, and a state detection circuit detects whether or not a state at the time of driving the motor is a predetermined state. A cell voltage detection circuit detects a voltage of the secondary cell at intervals corresponding to a detection result by the state detection circuit. A control unit drives the motor by selecting a drive pulse of energy corresponding to a detection result of the cell voltage detection circuit out of drive pulses of different energies. When the state detection circuit detects that a state at the time of driving the motor is the predetermined state, the cell voltage detection circuit detects the voltage of the secondary cell at intervals shorter than intervals when the state detection circuit detects that the state at the time of driving the motors is not the predetermined state.

### BACKGROUND OF THE INVENTION

1. Field of the Invention

The present invention relates to a motor drive device and an analogue electronic timepiece which uses the motor drive device.

2. Description of the Related Art

Conventionally, a stepping motor has been used for driving time hands of an analogue electronic timepiece or the like.

For example, in an electronic timepiece which uses a secondary cell as a power source and in which the secondary cell is charged by a photovoltaic cell whose voltage changes severely depending on the intensity of light, there has been developed an electronic timepiece where a power source voltage is detected, and energy of a motor drive pulse is changed corresponding to a range of the detected voltage (see JP-A-62-238484 (patent document 1)).

In the conventional electronic timepiece, a cell voltage of the secondary cell is detected every predetermined cycle (for example, 5 seconds or 10 seconds), and a motor drive pulse having a proper pulse width corresponding to the cell voltage is generated so as to drive a motor.

However, the secondary cell has, as shown in FIG. 8, a characteristic that a voltage change is large. FIG. 8 is a characteristic view showing the relationship between a voltage and a capacitance (mAh) of the secondary cell. As shown in FIG. 8, when a voltage of the secondary cell is equal to or below a predetermined voltage (region A) or the voltage of the secondary cell exceeds the predetermined voltage in the vicinity of a full-charged region (region B), the voltage change is large. Accordingly, when the detection of the cell voltage is delayed, a motor cannot be driven with a proper drive pulse thus giving rise to a possibility that the motor causes a malfunction.

Further, a generation voltage of the photovoltaic cell largely changes depending on the intensity of light which the photovoltaic cell receives and hence, a voltage of the secondary cell largely changes depending on a state of the photovoltaic cell at the time of charging the secondary cell. FIG. 9 shows the manner how the voltage of the secondary cell changes due to the presence or the non-presence of charging. As shown in FIG. 9, although the cell voltage is gently lowered as indicated by a straight line C when the secondary cell is consumed by driving the motor, once the charging of the secondary cell starts, the cell voltage is elevated sharply as indicated by a straight line D. Accordingly, when the detection of the cell voltage is delayed at the time of charging the secondary cell, the motor cannot be driven with a proper drive pulse thus giving rise to a possibility that the motor causes a malfunction.

Further, in an analogue electronic timepiece provided with a chronograph function, a chronograph hand indicative of a measured time is driven at a high speed and at short intervals compared to a time hand such as a second hand. FIG. 10 is an explanatory view where the hand driving of the time hand and the chronograph hand and a charged state and a non-charged state of the secondary cell are associated with each other.

In FIG. 10, although a time motor for driving the time hand and a chronograph motor for driving the chronograph hand are driven with a main drive pulse P1, the chronograph motor is driven at a high speed and at short intervals compared to the time motor. Before the time motor is driven, voltage detection timings for the secondary cell are generated respectively, the cell voltage is detected, and the time motor and the chronograph motor are driven with main drive pulses P1-1 and P1-2 with energies corresponding to the cell voltages (energies being set to have the relationship of P1-1<P1-2).

In regions I and III, the secondary cell is under charging and hence, the time motor and the chronograph motor can be normally driven even with the main drive pulse P1-1 of small energy. However, when a charging state enters a region II so that the charging of the secondary cell is stopped (discharging state), the cell voltage is lowered.

In driving the motor for the time hand, the voltage detection is performed before each driving and the motor is driven with a main drive pulse corresponding to the cell voltage at the time and hence, no malfunction occurs. Further, also in a region II-2, the voltage detection of the secondary cell is performed and hence, the chronograph motor is driven with a proper main drive pulse P1-2 whereby there is no possibility that a malfunction occurs. However, in driving the chronograph motor, the cell voltage is not detected in a region II-1 and hence, the chronograph motor cannot be rotated with the main drive pulse P1-1 so that there is a possibility that a malfunction occurs. Also in a case of the time motor, there exists a possibility that a malfunction occurs when the time hand is driven at a high speed in the same manner.

In this manner, with respect to the conventional electronic timepiece, when a motor driving state is a predetermined state ((1) at the time where the voltage is low due to discharging of the secondary cell or at the time where the voltage is high such that the voltage is close to a voltage when the secondary cell 2 is fully charged, (2) at the time where the secondary cell is charged or (3) at the time where a high-speed hand movement is performed and charging or discharging occurs within a predetermined period so that the voltage of the secondary cell sharply changes), a proper drive pulse is not selected thus giving rise to a possibility that the motor causes a malfunction.

### SUMMARY OF THE INVENTION

It is an aspect of the present application to drive a motor with a proper drive pulse even when a motor driving state is a predetermined state where a malfunction is liable to occur.

According to the aspect of the present application, there is provided a motor drive device which includes: a secondary cell which supplies at least drive power for a motor; a state detection means which detects whether or not a state at the time of driving the motor is a predetermined state; a voltage detection means which detects a voltage of the secondary cell at intervals corresponding to a detection result by the state detection means; and a control means which drives the motor by selecting a drive pulse of energy corresponding to a detection result of the voltage detection means out of plural kinds of drive pulses which differ from each other in energy, wherein the voltage detection means, when the state detection means detects that a state at the time of driving the motor is a predetermined state, detects the voltage of the secondary cell at intervals shorter than intervals when the state detection means detects that the state at the time of driving the motor is not in the predetermined state.

According to another aspect of the present application, there is provided an analogue electronic timepiece which includes: a motor which rotates a time hand; and a motor drive device which drives the motor, wherein the analogue electronic timepiece is constituted using the motor drive device.

According to the motor drive device of the present application, the motor can be driven with a proper drive pulse even in a state where a motor drive state is a predetermined state where the motor is liable to cause a malfunction.

Further, according to the analogue electronic timepiece of the present application, the motor can be driven with a proper drive pulse even in a state where a motor drive state is a predetermined state where the motor is liable to cause a malfunction and hence, an accurate hand moving operation can be acquired.

### BRIEF DESCRIPTION OF THE DRAWINGS

FIG. 1 is a block diagram of an analogue electronic timepiece which uses a motor drive device according to an embodiment of the present invention;

FIG. 2 is a flowchart showing the manner of operation of the motor drive device and the analogue electronic timepiece according to the embodiment of the present invention;

FIG. 3 is an explanatory view of the motor drive device and the analogue electronic timepiece according to the embodiment of the present invention;

FIG. 4 is an explanatory view of the motor drive device and the analogue electronic timepiece according to the embodiment of the present invention;

FIG. 5 is a flowchart showing the manner of operation of the motor drive device and the analogue electronic timepiece according to the embodiment of the present invention;

FIG. 6 is a flowchart showing the manner of operation of a motor drive device and an analogue electronic timepiece according to another embodiment of the present invention;

FIG. 7 is an explanatory view of the motor drive device and the analogue electronic timepiece according to another embodiment of the present invention;

FIG. 8 is a characteristic view showing the relationship between a voltage and a capacitance of a secondary cell;

FIG. 9 is a charging characteristic view of the secondary cell; and

FIG. 10 is an explanatory view of a conventional analogue electronic timepiece.

### DETAILED DESCRIPTION OF THE PREFERRED EMBODIMENTS

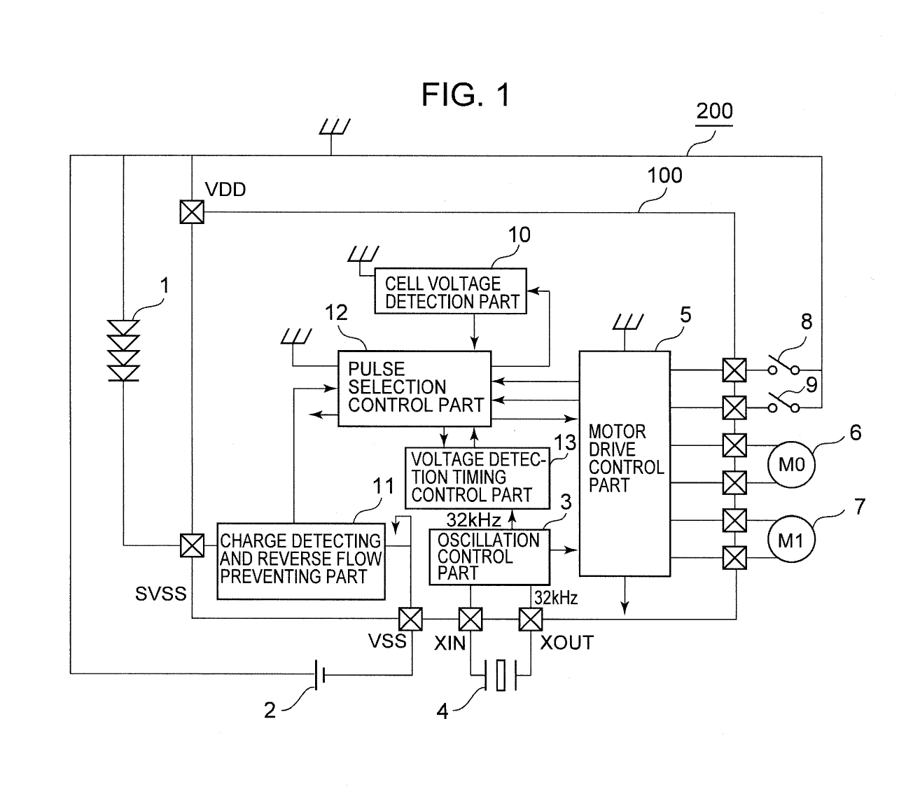

FIG. 1 is a block diagram of an analogue electronic timepiece which uses a motor drive device according to an embodiment of the present invention, and shows a case where the analogue electronic timepiece is a chronograph timepiece.

In FIG. 1, an analogue electronic timepiece 200 includes: a photovoltaic cell 1 which constitutes a power generating means or a charging means; a secondary cell 2 which constitutes a power source; a time motor 6 which drives a time hand; a chronograph motor 7 which drives a chronograph hand (not shown in the drawing) indicative of a measured time; a start/stop switch 8 for instructing start and stop of a time measuring (chronograph) operation; a reset switch 9 for resetting a measured time to 0; and a motor drive device 100.

The photovoltaic cell 1 receives light, generates power, and charges the secondary cell 2 with the generated power. The secondary cell 2 is a power source which supplies drive power to respective electronic constitutional elements of the analogue electronic timepiece 200 and a power source which supplies drive power at least to the motors 6, 7.

The motors 6, 7 are timepiece-use stepping motors having a well-known constitution, wherein the time motor 6 is a first stepping motor which is driven at predetermined first intervals, and the chronograph motor 7 is a second stepping motor which is driven at predetermined second intervals shorter than the first intervals. The time motor 6 is driven by a motor drive control part 5 and makes time hands (for example, an hour hand, a minute hand and a second hand not shown in the drawing) to indicate the present time by driving the time hands. The chronograph motor 7 drives the chronograph hand (not shown in the drawing) so as to make the chronograph hand display the measured time.

The start/stop switch 8 is a switch for instructing the start and the stop of the time measuring operation alternately. By operating the start/stop switch in a state where the time measurement is not started, the time measuring operation is started. By operating the start/stop switch in a state where the time measurement is underway, the time measuring operation is stopped. After the time measurement is finished, the measured time is reset to 0 by operating the reset switch 9 so as to return the chronograph hand to 0. Also by operating the reset switch 9 during the time measurement, the measurement time can be reset to 0 so as to return the chronograph hand to 0.

The motor drive device 100 includes: an oscillation control part 3; a crystal oscillator 4 which constitutes an oscillation circuit together with the oscillation control part 3; the motor drive control part 5; a cell voltage detection part 10 which detects a voltage of the secondary cell 2; a charge detecting and reverse flow preventing part 11 which detects whether or not the secondary cell 2 is under charging by the photovoltaic cell 1 and prevents an electric current from flowing toward the photovoltaic cell 1 from the secondary cell 2; a pulse selection control part 12 which instructs a drive pulse to be selected from plural kinds of main drive pulses P1 which differ in energy and a correction drive pulse P2 which has energy larger than energies of the respective main drive pulses P1; and a voltage detection timing control part 13 which controls timing at which the voltage of the secondary cell 2 is detected.

The voltage detection timing control part 13 outputs a detection timing signal for allowing the cell voltage detection part 10 to perform a voltage detection at intervals corresponding to a detection interval setting signal from the pulse selection control part 12 to the pulse selection control part 12.

The cell voltage detection part 10 detects the voltage of the secondary cell 2 in response to a detection sampling signal from the pulse selection control part 12, and outputs a voltage detection signal indicative of the voltage to the pulse selection control part 12. The charge detecting and reverse flow preventing part 11 outputs a charge detection signal which indicates that the secondary cell 2 is under charging to the pulse selection control part 12 when a voltage of the photovoltaic cell 1 is higher than the voltage of the secondary cell 2, and outputs a charge detection signal which indicates that the secondary cell 2 is not under charging to the pulse selection control part 12 when the voltage of the photovoltaic cell 1 is not higher than the voltage of the secondary cell 2.

The motor drive control part 5 performs the time measuring operation by dividing the frequency of a signal of predetermined frequency inputted from the oscillation circuit constituted of the oscillation control part 3 and the crystal oscillator 4 and by generating a clock signal which becomes a reference in the time measurement. The motor drive control part 5 outputs a hand moving timing signal to the pulse selection control part 12 each time hand moving timing is generated at preset predetermined intervals. The motor drive control part 5 drives the motors 6, 7 with a drive pulse having energy corresponding to a pulse selection signal from the pulse selection control part 12 each time the hand moving timing is generated. Further, when a time measurement start instruction is inputted by the start/stop switch 8, the motor drive control part 5 outputs a chronograph RUN signal which indicates that the time measurement is underway to the pulse selection control part 12.

Although the pulse selection control part 12 is explained in detail later, the pulse selection control part 12 controls intervals of the voltage detection of the secondary cell 2 performed by the cell voltage detection part 10 by performing a change control of supply intervals of the detection sampling signal to the cell voltage detection part 10 in response to the voltage detection signal from the cell voltage detection part 10, the charge detection signal from the charge detecting and reverse flow preventing part 11, or the chronograph RUN signal from the motor drive control part 5. Further, the pulse selection control part 12, at the time of performing the change control of the voltage detection intervals, outputs a detection interval setting signal indicative of new detection timing to the voltage detection timing control part 13. The voltage detection timing control part 13 outputs a detection timing signal to the pulse selection control part 12 at intervals corresponding to the detection interval setting signal. The pulse selection control part 12 outputs the detection sampling signal to the cell voltage detection part 10 in response to each detection timing signal.

The photovoltaic cell 1 constitutes the charging means or the power generating means. The cell voltage detection part 10 and the voltage detection timing control part 13 constitute a voltage detection means. The cell voltage detection part 10, the charge detecting and reverse flow preventing part 11, the pulse selection control part 12 and the voltage detection timing control part 13 constitute a state detection means. The oscillation control part 3, the crystal oscillator 4, the motor drive control part 5 and the pulse selection control part 12 constitute a control means.

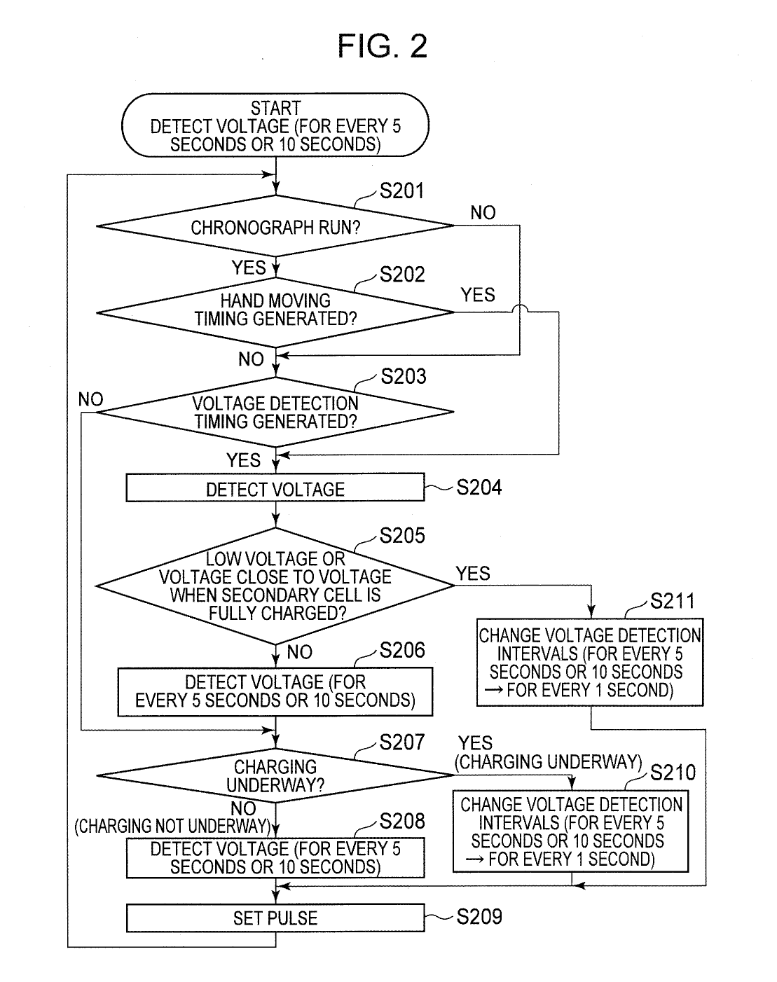

FIG. 2 is a flowchart showing the manner of operation of the motor drive device and the analogue electronic timepiece of the embodiment of the present invention, and is a flowchart showing change processing of the voltage detection intervals.

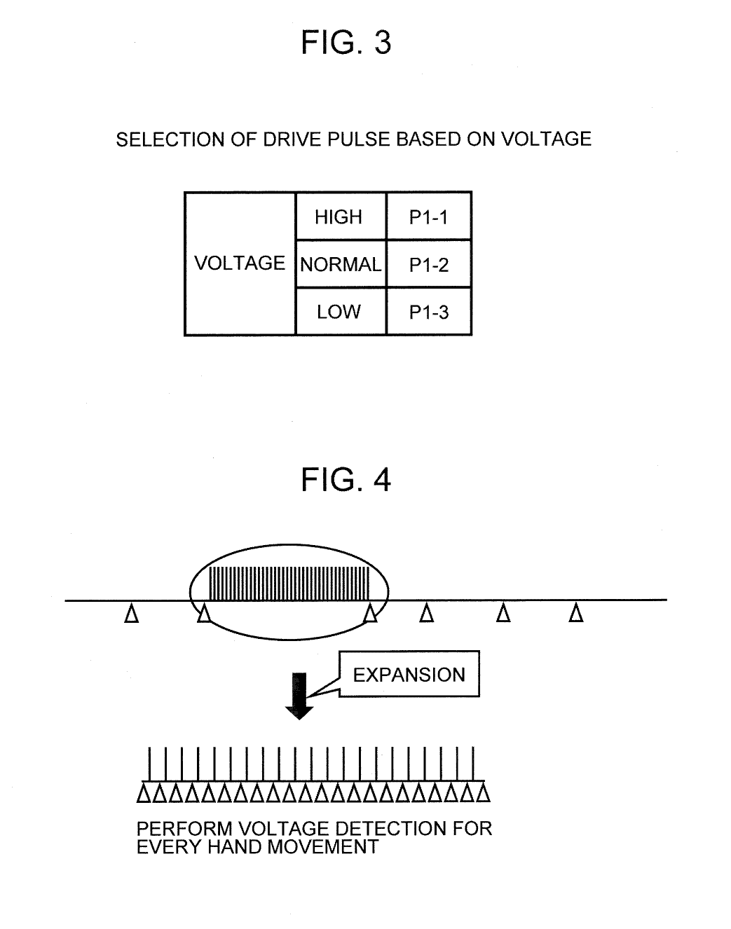

FIG. 3 is an explanatory view of the manner of operation of the motor drive device and the analogue electronic timepiece of the embodiment of the present invention.

FIG. 4 is an explanatory view of the manner of operation of the motor drive device and the analogue electronic timepiece of the present invention, and is a view showing the manner of operation of the motor drive device and the analogue electronic timepiece at the time of moving the chronograph hand.

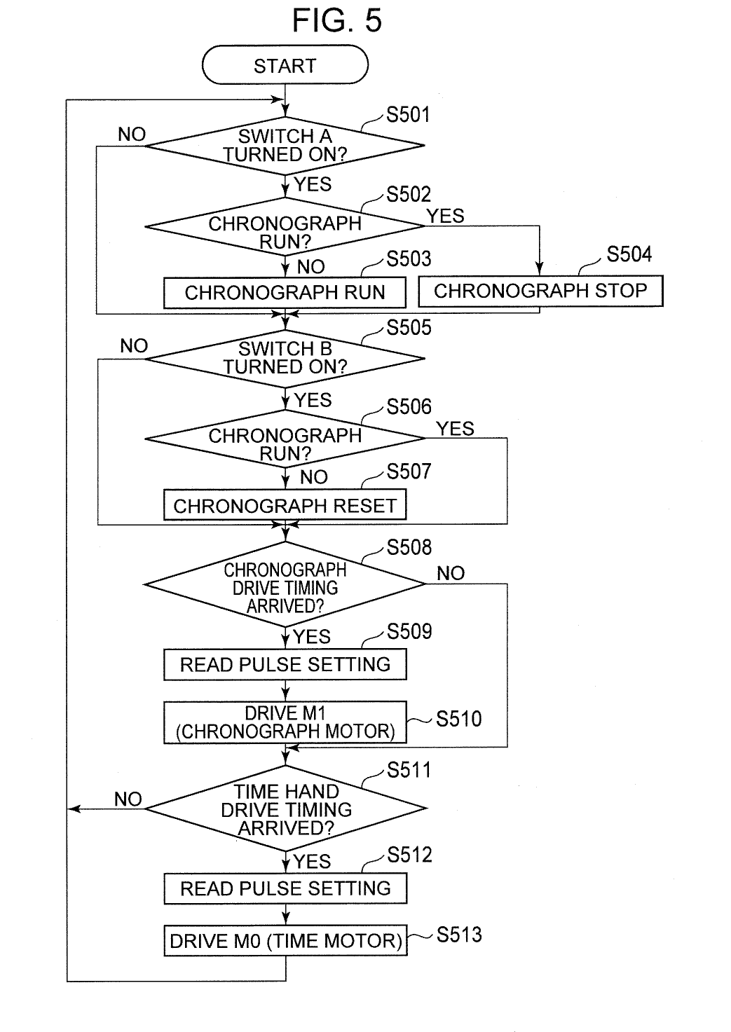

FIG. 5 is a flowchart showing the manner of operation of the motor drive device and the analogue electronic timepiece of the embodiment of the present invention, and is a flowchart showing driving operation of the motors 6, 7.

Hereinafter, the manner of operation of the motor drive device and the analogue electronic timepiece according to the embodiment of the present invention is explained in detail in conjunction with FIG. 1 to FIG. 5.

First, as an initial state, assume that the voltage detection intervals at which the cell voltage detection part 10 detects the voltage of the secondary cell 2 are set to 5 seconds or 10 seconds.

When the pulse selection control part 12 receives the chronograph RUN signal which indicates that the time measuring operation is underway from the motor drive control part 5 (step S201 in FIG. 2) but does not thereafter receive the hand moving timing signal which indicates that the hand moving timing has arrived from the motor drive control part 5 (step S202), the pulse selection control part 12 determines whether or not the pulse selection control part 12 receives the voltage detection timing signal from the voltage detection timing control part 13 (that is, whether or not timing at which the voltage of the secondary cell 2 is detected has arrived) (step S203).

When the pulse selection control part 12 determines that the voltage detection timing has arrived in processing step S203, the pulse selection control part 12 outputs the detection sampling signal to the cell voltage detection part 10 so that the cell voltage detection part 10 detects the voltage of the secondary cell 2 (step S204).

The cell voltage detection part 10 detects the voltage of the secondary cell 2 in response to the detection sampling signal, and outputs the voltage detection signal indicative of the voltage of the secondary cell 2 to the pulse selection control part 12.

When the pulse selection control part 12 determines, based on the voltage detection signal from the cell voltage detection part 10, that the secondary cell 2 is not in “a state where the voltage of the secondary cell 2 exceeds a predetermined first voltage (for example, a voltage close to a voltage when the secondary cell 2 is fully charged) or a state where the voltage of the secondary cell 2 is equal to or below a second voltage lower than the predetermined first voltage” (that is, the voltage of the secondary cell 2 is neither in the state where the voltage of the secondary cell 2 exceeds the predetermined first voltage (for example, a voltage close to a voltage when the secondary cell 2 is fully charged) and nor in the state where the voltage of the secondary cell 2 is equal to or below the second voltage lower than the first voltage) (step S205), the pulse selection control part 12 sets the voltage detection intervals of the secondary cell 2 to 5 seconds or 10 seconds in the same manner as the initial state (step S206).

Next, when the pulse selection control part 12 determines that the secondary cell 2 is not under charging by the photovoltaic cell 1 based on the charge detection signal from the charge detecting and reverse flow preventing part 11 (step S207), the pulse selection control part 12 sets the voltage detection intervals of the secondary cell 2 to 5 seconds or 10 seconds in the same manner as the initial state (step S208).

Next, the pulse selection control part 12 selects a drive pulse based on the voltage detection signal by looking up a table shown in FIG. 3 which is pre-stored in a storage part (not shown in the drawing) of the pulse selection control part 12, and processing returns to processing step S201 (step S209). In an example of the table shown in FIG. 3, when the voltage of the secondary cell 2 exceeds the predetermined first voltage (for example, a high voltage close to a voltage when the secondary cell 2 is fully charged), the pulse selection control part 12 selects a main drive pulse P1-1 which is a rectangular wave having a minimum pulse width. When the voltage of the secondary cell 2 is equal to or below the first voltage and exceeds the second voltage (normal voltage), the pulse selection control part 12 selects a main drive pulse P1-2 which is a rectangular wave having a pulse width larger than the pulse width of the main drive pulse P1-1. When the voltage of the secondary cell 2 is equal to or below the second voltage (low voltage), the pulse selection control part 12 selects a main drive pulse P1-3 which is a rectangular wave and has a pulse width larger than the pulse width of the main drive pulse P1-2.

In this manner, by increasing the pulse width of the main drive pulse P1 along with the lowering of the voltage of the secondary cell 2, the decrease of the drive energy due to the lowering of the voltage can be prevented. Accordingly, even when the voltage of the secondary cell 2 is lowered, the motors 6, 7 can be surely rotated. On the other hand, when the voltage of the secondary cell 2 is high, the driving of the motors 6, 7 with the main drive pulse P1 having excessively large energy can be prevented thus suppressing the power consumption.

When the main drive pulse P1 is not formed in a rectangular waveform but is constituted of a plurality of comb-tooth-shaped pulses, the decrease of the drive energy due to the lowering of the voltage may be prevented by changing the number of comb-tooth-shaped pulses or by changing a duty ratio along with a voltage change. Further, the decrease of the drive energy due to the lowering of the voltage may be prevented also by changing a crest value along with the voltage change.

When the pulse selection control part 12 determines that the secondary cell 2 is under charging by the photovoltaic cell 1 in processing step S207, the pulse selection control part 12 changes the voltage detection intervals of the secondary cell 2 to intervals (1 second intervals in this embodiment) shorter than the intervals in the initial state (step S210), and the processing advances to processing step S209. When the secondary cell 2 is under charging, the voltage of the secondary cell 2 becomes high. By shortening the voltage detection intervals, it is possible to quickly change the drive pulse to a drive pulse having proper energy.

When the pulse selection control part 12 determines that the voltage of the secondary cell 2 exceeds the first voltage or is equal to or below the second voltage in processing step S205, the pulse selection control part 12 changes the voltage detection intervals of the secondary cell 2 to intervals (1 second intervals in this embodiment) shorter than the intervals in the initial state (step S211), and the processing advances to processing step S209.

When the pulse selection control part 12 determines that the voltage detection timing has not arrived in processing step S203, the processing advances to processing step S207.

When the pulse selection control part 12 determines that the hand moving timing is generated in processing step S202, the processing advances to processing step S204, and the voltage of the secondary cell 2 is detected. Due to such an operation, the voltage of the secondary cell 2 is detected each time the chronograph hand is moved as shown in FIG. 4.

When the pulse selection control part 12 determines that the pulse selection control part 12 does not receive the chronograph RUN signal in processing step S201, the processing advances to processing step S203.

Hereinafter, processing in processing steps S201 to S211 is repeated at a predetermined cycle.

As described above, when the chronograph operation is performed, the cell voltage of the secondary cell 2 is detected each time the hand moving timing of the chronograph hand arrives. When the chronograph operation is not operated, the cell voltage of the secondary cell 2 is detected each time predetermined voltage detection timing arrives, the voltage detection intervals are set to intervals corresponding to the cell voltage, and the drive pulse is set to a drive pulse corresponding to the voltage of the secondary cell 2. Further, when the secondary cell 2 is under charging, the voltage detection intervals are shortened compared to a case where charging is not performed, and the drive pulse is set to a drive pulse corresponding to the cell voltage of the secondary cell 2.

Accordingly, when it is detected that a state at the time of driving the motors 6, 7 is a predetermined state, the voltage of the secondary cell 2 is detected at intervals shorter than intervals when the state at the time of driving the motors 6, 7 is not the predetermined state and hence, it is possible to accurately detect the voltage of the secondary cell 2. Accordingly, the motors 6, 7 can be driven with a proper drive pulse corresponding to the voltage of the secondary cell 2 whereby the motors 6, 7 can be more surely rotated and the power saving can be realized.

As shown in FIG. 5, the pulse selection control part 12 drives the motors 6, 7 using the drive pulses set as described above.

In FIG. 5, in the case where the motor drive control part 5 determines that the start/stop switch (switch A) 8 is operated (step S501), when the time measuring operation is not performed (step S502), the motor drive control part 5 starts the time measuring operation, and outputs the chronograph RUN signal to the pulse selection control part 12 (step S503) and, thereafter, the processing advances to processing step S505.

When the motor drive control part 5 determines that the time measuring operation is performed in processing step S502, the processing advances to processing step S505 after the time measuring operation is stopped (step S504).

When the motor drive control part 5 determines that the start/stop switch (switch A) 8 is not operated in processing step S501, the processing advances to processing step S505.

The motor drive control part 5 determines whether or not the reset switch (switch B) 9 is operated in processing step S505.

In the case where the motor drive control part 5 determines that the reset switch (switch B) 9 is operated in processing step S505, when the motor drive control part 5 determines that the time measuring operation is not performed (step S506), the motor drive control part 5 resets the measured time (S507).

Next, when the motor drive control part 5 determines that timing at which the chronograph hand is driven arrives (step S508), the motor drive control part 5 reads information of the main drive pulse P1 set as describe above (step S509), and drives the chronograph motor 7 with the drive pulse P1 (step S510).

Next, when the motor drive control part 5 determines that timing at which the time hand is driven arrives (step S511), the motor drive control part 5 reads information of the set main drive pulse P1 (step S512), drives the time motor 6 with the drive pulse P1 (step S513) and, thereafter, the processing returns to processing step S501.

When the motor drive control part 5 determines that the timing at which the time hand is drive has not arrived in processing step S511, the processing returns to processing step S501.

When the motor drive control part 5 determines that the timing at which the chronograph hand is driven has not arrived in processing step S508, the processing advances to processing step S511.

When the motor drive control part 5 determines that the time measuring operation is performed in processing step S506, the processing advances to processing step S508.

When the motor drive control part 5 determines that the reset switch (switch B) 9 is not operated in processing step S505, the processing advances to processing step S508.

By repeating the above-mentioned operations, the time hand moving operation and the chronograph hand moving operation are performed with the set drive pulse P1 so that the time display and the display of the measured time are performed.

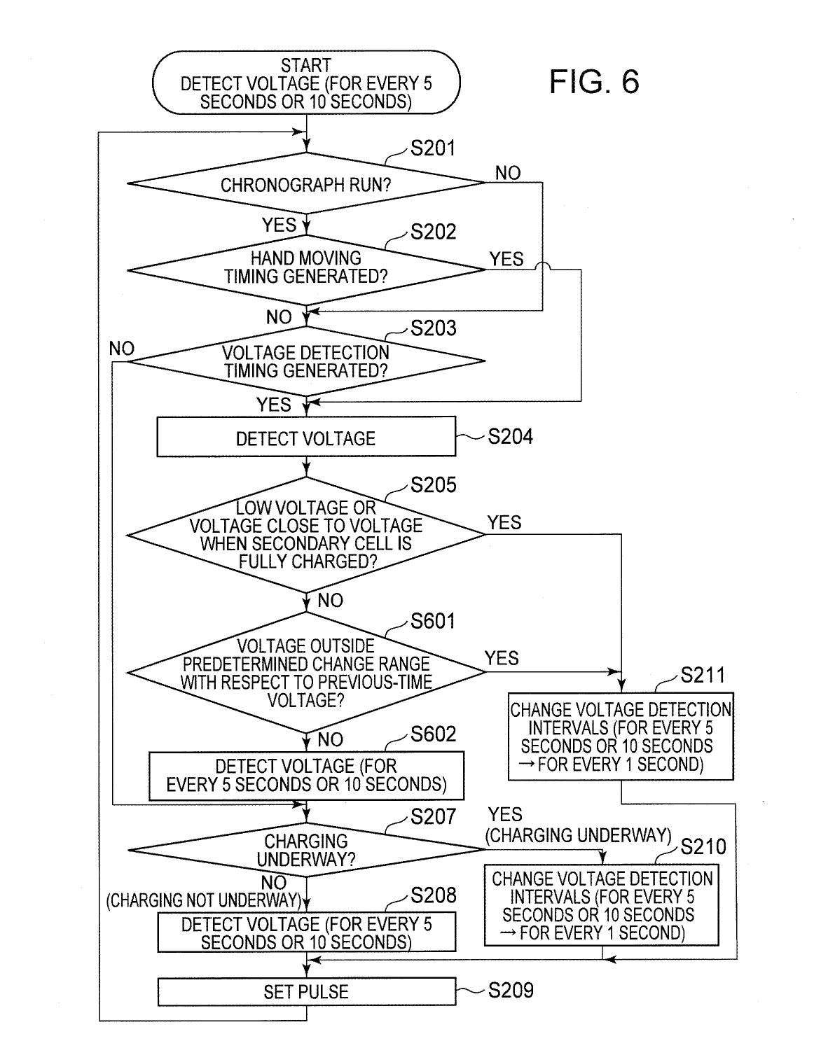

FIG. 6 is a flowchart showing an operation of another embodiment of the present invention. FIG. 6 is also a flowchart showing processing for changing the voltage detection intervals. In FIG. 6, a step where the same processing is performed as the corresponding step in FIG. 2 is given the same symbol.

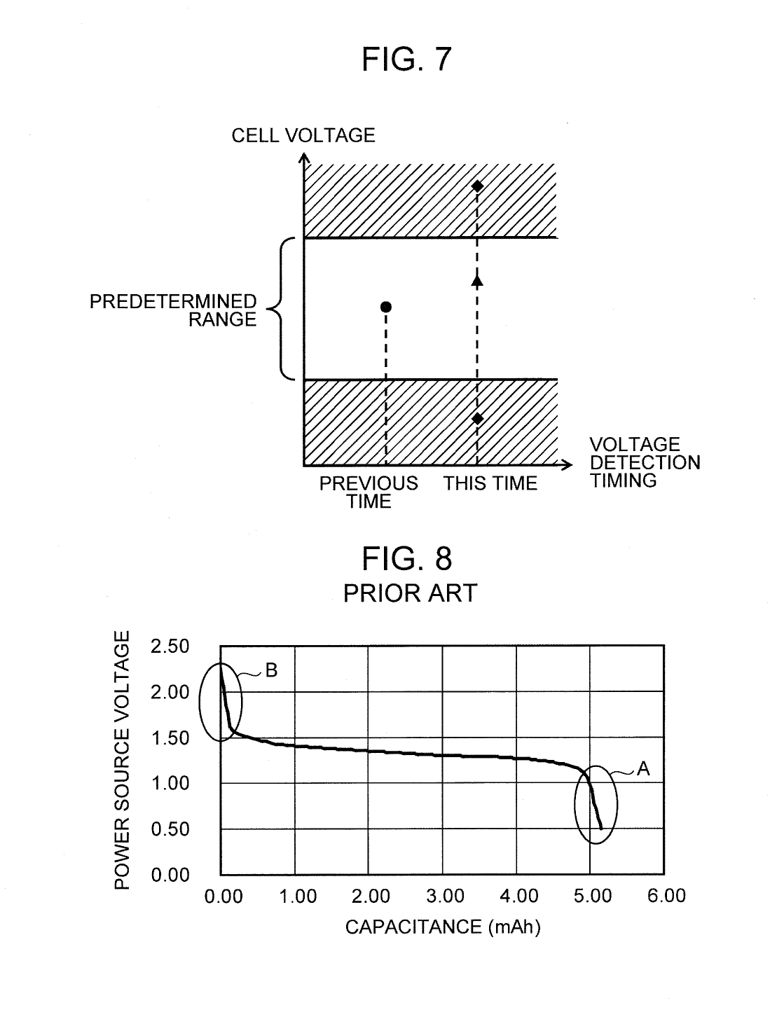

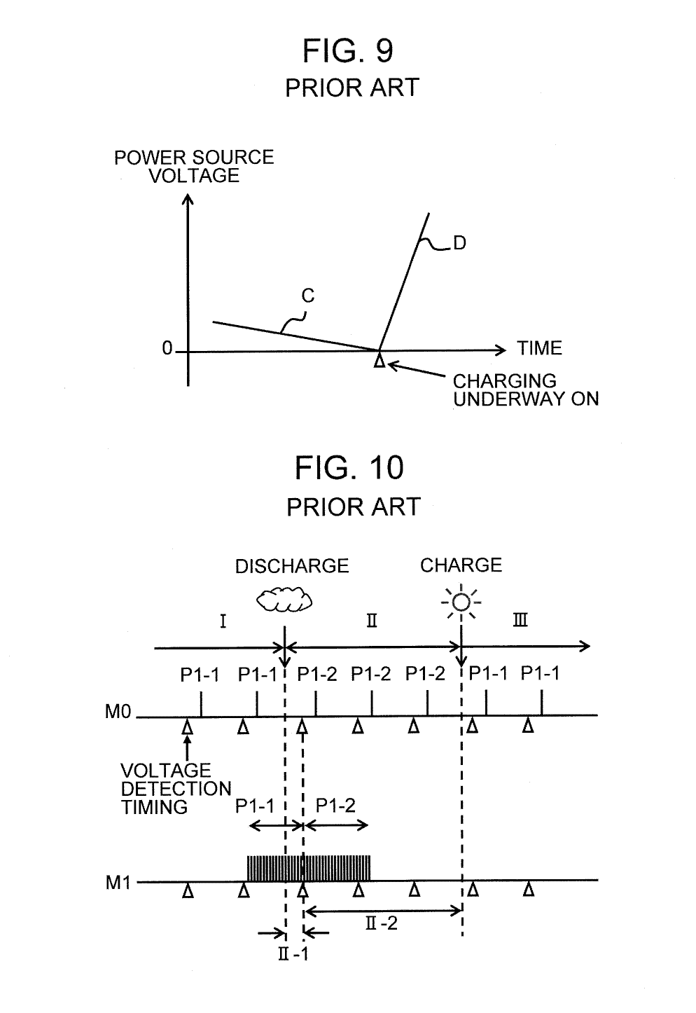

FIG. 7 is an operational explanatory view showing another embodiment of the present invention.

With respect to the constitution and the manner of operation shown FIG. 1 and FIG. 3 to FIG. 5, this another embodiment adopts the same constitution and the manner of operation as the above-mentioned embodiment.

In the above-mentioned embodiment, the explanation has been made with respect to the case where if the state at the time of driving the motor is the predetermined state, the voltage of the secondary cell 2 is detected at intervals shorter than intervals when the state is not the predetermined state, and as the example of the predetermined state, the state where the voltage of the secondary cell 2 exceeds the predetermined first voltage, the state where the voltage of the secondary cell 2 is equal to or below the second voltage lower than the first voltage, the state where the secondary cell 2 is under charging, and the state where the second stepping motor 7 is driven are named. In this another embodiment, further, when a voltage change rate of the secondary cell 2 exceeds a predetermined range, the voltage detection intervals are set shorter than voltage detection intervals when the voltage change rate is equal to or below the predetermined range.

Hereinafter, operations of the motor drive device and the analogue electronic timepiece according to this another embodiment are explained with respect to the constitutions which make this another embodiment different from the above-mentioned embodiment in conjunction with FIG. 1 and FIG. 3 to FIG. 7.

When the pulse selection control part 12 determines that the voltage detection timing has arrived in processing step S203 shown in FIG. 6 in the same manner as the above-mentioned embodiment, the pulse selection control part 12 outputs the detection sampling signal to the cell voltage detection part 10 so that the cell voltage detection part 10 detects the voltage of the secondary cell 2 (step S204).

The cell voltage detection part 10 detects the voltage of the secondary cell 2 in response to the detection sampling signal, and outputs the voltage detection signal indicative of the detected voltage (voltage detection value) of the secondary cell 2 to the pulse selection control part 12.

The pulse selection control part 12 determines, based on the voltage detection signal from the cell voltage detection part 10, whether or not “the voltage of the secondary cell 2 is in a state where the voltage exceeds the predetermined first voltage (for example, a voltage close to a voltage when the secondary cell 2 is fully charged) or in a state where the voltage is equal to or below the second voltage lower than the first voltage” (step S205).

When the pulse selection control part 12 determines that the voltage of the secondary cell 2 is neither in the state where the voltage exceeds the predetermined first voltage (for example, a voltage close to a voltage when the secondary cell 2 is fully charged) nor in the state where the voltage is equal to or below the second voltage lower than the first voltage in processing step S205, the pulse selection control part 12 compares the voltage detection value of the secondary cell 2 which the cell voltage detection part 10 detects in processing step S204 of the previous cycle and the voltage detection value of the secondary cell 2 which the cell voltage detection part 10 detects in processing step S204 of this cycle to each other, and determines whether or not the voltage detection value of the secondary cell 2 detected this time is outside a predetermined change range with respect to the voltage detection value of the secondary cell 2 detected previous time (step S601).

The pulse selection control part 12, as shown in FIG. 7, determines whether or not the voltage detection value of the secondary cell 2 detected this time is outside the predetermined change range with respect to the voltage detection value of the secondary cell 2 detected previous time.

In FIG. 7, the voltage detection timing at which the cell voltage detection part 10 detects the voltage of the secondary cell 2 is taken on an axis of abscissas, and the voltage detection value of the secondary cell 2 which is detected by the cell voltage detection part 10 is taken on an axis of ordinates. A black circular dot indicates an example of the voltage detection value of the secondary cell 2 detected previous time, and a black triangular dot and a black rhombic dot indicate examples of the voltage detection value of the secondary cell 2 detected this time.

A predetermined change range (for example, ±0.5V) with the voltage detection value (black circular dot) of the secondary cell 2 detected previous time set as the center is set as a predetermined range (a threshold value of the change range with respect to the previous-time voltage detection value). With respect to the examples of the voltage detection value of the secondary cell 2 detected this time, the black triangular dot is a dot within the predetermined change range, and the black rhombic dot is a dot outside the predetermined change range. As a method for setting the change range, named are various methods including a method where the change range is set to a range which is a fixed rate of the voltage detection value of the secondary cell 2 detected previous time (for example, ±20% of the voltage detection value of the secondary cell 2 detected previous time).

When the voltage detection value detected this time is not outside the predetermined change range with respect to the voltage detection value detected previous time, a voltage change rate of the secondary cell 2 is small and hence, the pulse selection control part 12 sets the voltage detection intervals to the long voltage detection intervals in the same manner as the detection intervals in the initial state (for every 5 seconds or 10 seconds in this embodiment), and the processing advances to processing step S207 (step S602).

On the other hand, when the voltage detection value detected this time is outside the predetermined change range with respect to the voltage detection value detected previous time in processing step S601, the voltage change rate of the secondary cell 2 is large so that a voltage change is rapid change whereby there is a possibility that the drive pulse is not changed to a drive pulse proper for motor driving with the above-mentioned long voltage detection intervals. Accordingly, the pulse selection control part 12 sets the voltage detection intervals to short voltage detection intervals (1 second in this embodiment) (step S211).

Hereinafter, in the same manner as the above-mentioned embodiment, processing in processing steps S201 to S205, S207 to S211, S601, and S602 is repeated at a predetermined cycle. Accordingly, this embodiment can acquire not only advantageous effects substantially equal to the advantageous effects of the above-mentioned embodiment but also can drive the motors 6, 7 with proper drive pulses by shortening the voltage detection intervals when the voltage change rate is large even when an absolute value of the voltage of the secondary cell 2 is high. Accordingly, this embodiment can acquire advantageous effects that the motors 6, 7 can be rotated more reliably and power saving can be realized.

As has been explained heretofore, the motor drive devices according to the respective embodiments of the present invention are characterized in that the motor drive device includes the secondary cell which supplies at least drive power for the motor; the state detection means which detects whether or not a state at the time of driving the motor is a predetermined state; the voltage detection means which detects the voltage of the secondary cell at intervals corresponding to a detection result by the state detection means; and the control means which drives the motor by selecting a drive pulse of energy corresponding to a detection result of the voltage detection means out of plural kinds of drive pulses which differ from each other in energy, wherein the voltage detection means, when the state detection means detects that a state at the time of driving the motor is a predetermined state, detects the voltage of the secondary cell at intervals shorter than intervals when the state detection means detects that the state at the time of driving the motor is not in the predetermined state.

Here, the above-mentioned predetermined state may be a state where the voltage of the secondary cell exceeds a predetermined first voltage, a state where the voltage of the secondary cell is equal to or below a second voltage which is lower than the first voltage or a state where a voltage detection value of this time is outside a predetermined change range with respect to a voltage detection value of previous time.

The motor drive device may include a charging means which charges the secondary cell, and the predetermined state may be a state where the secondary cell is under charging by the charging means.

The motor drive device may include, as the above-mentioned motor, a first stepping motor which is driven at predetermined first intervals, and a second stepping motor which is driven at predetermined second intervals shorter than the first intervals, and the predetermined state may be a state where the second stepping motor is driven by the control means.

Further, the voltage detection means may detect the voltage of the secondary cell each time the second stepping motor is driven by the control means.

Accordingly, a voltage of the secondary cell can be quickly detected when the state at the time of driving the motor is the predetermined state where an erroneous operation is liable to occur so that the motor can be driven by changing a drive pulse to a proper drive pulse.

Further, by driving the motor with a main drive pulse having larger energy along with the lowering of the voltage of the secondary cell, the decrease of drive energy due to the lowering of the voltage is prevented and hence, even when the voltage of the secondary cell is lowered, the motor can be surely rotated. On the other hand, when the voltage of the secondary cell is high, driving of the motor with a main drive pulse having excessive energy can be prevented thus acquiring an advantageous effect that power consumption can be suppressed.

Further, in the analogue electronic timepiece according to the embodiment of the present invention which includes the motor which rotates the time hand and the motor drive device which drives the motor, by using the above-mentioned motor drive device 100 as the motor drive device, the voltage of the secondary cell can be quickly detected when the state at the time of driving the motor is a predetermined state where an erroneous operation is liable to occur so that the motor can be driven by changing the drive pulse to a proper drive pulse whereby it is possible to acquire advantageous effects such as the prevention of an error in hand movement or the realization of power saving.

Further, in the analogue electronic timepiece according to the embodiment of the present invention which includes the time hand stepping motor which rotates the time hand, the chronograph hand stepping motor which rotates the chronograph hand, and the motor drive device which drives each stepping motor, the above-mentioned motor drive device 100 is used as the motor drive device, the first stepping motor is used as the time hand stepping motor, and the second stepping motor is used as the chronograph hand stepping motor. Accordingly, the voltage of the secondary cell can be detected each time the second stepping motor is driven for hand movement so that the second stepping motor can be driven by changing the drive pulse to a proper drive pulse whereby it is possible to acquire advantageous effects such as the prevention of an error in the hand movement or the realization of power saving.

In the above-mentioned embodiments, the explanation has been made by taking the chronograph timepiece as the example. However, the present invention is also applicable to an analogue electronic timepiece or the like where only the time hand is movably driven. In this case, only the time motor may be used as the motor.

The motor drive device is also applicable to driving of a motor for driving a calendar or the like besides the time hand.

Although the example of the electronic timepiece is explained as the application example of the motor, the motor drive device is applicable to various electronic apparatuses which use a motor.

The motor drive device according to the present invention is applicable to various electronic apparatuses which use a motor.

Further, the analogue electronic timepiece according to the present invention is also applicable to a chronograph timepiece, an analogue electronic watch having a calendar function, various analogue electronic timepieces having a calendar function such as an analogue electronic clock having a calendar function, and various analogue electronic timepieces having no calendar function.

What is claimed is:

1. A motor drive device comprising:
a secondary cell which supplies at least drive power for a motor;
a state detection means which detects whether or not a state at the time of driving the motor is a predetermined state;
a voltage detection means which detects a voltage of the secondary cell at intervals corresponding to a detection result by the state detection means; and
a control means which drives the motor by selecting a drive pulse of energy corresponding to a detection result of the voltage detection means out of plural kinds of drive pulses which differ from each other in energy, wherein
the voltage detection means, when the state detection means detects that a state at the time of driving the motor is a predetermined state, detects the voltage of the secondary cell at intervals shorter than intervals when the state detection means detects that the state at the time of driving the motor is not in the predetermined state.

2. The motor drive device according to claim 1, wherein the predetermined state is a state where the voltage of the secondary cell exceeds a predetermined first voltage, a state where the voltage of the secondary cell is equal to or below a second voltage smaller than the first voltage or a state where a present-time voltage detection value falls outside a predetermined change range with respect to a previous-time voltage detection value.

3. The motor drive device according to claim 1, comprising a charging means which charges the secondary cell, wherein the predetermined state is a state where the secondary cell is under charging by the charging means.

4. The motor drive device according to claim 1, comprising, as the motor, a first stepping motor which is driven at predetermined first intervals, and a second stepping motor which is driven at predetermined second intervals shorter than the first intervals, wherein
the predetermined state is a state where the second stepping motor is driven by the control means.

5. The motor drive device according to claim 4, wherein the voltage detection means detects the voltage of the secondary cell each time the second stepping motor is driven by the control means.

6. An analogue electronic timepiece comprising:
a motor which rotates a time hand; and
a motor drive device which drives the motor, wherein
the motor drive device according to claim 1 is used as the motor drive device.

7. An analogue electronic timepiece comprising:
a motor which rotates a time hand; and
a motor drive device which drives the motor, wherein
the motor drive device according to claim 2 is used as the motor drive device.

8. An analogue electronic timepiece comprising:
a motor which rotates a time hand; and
a motor drive device which drives the motor, wherein
the motor drive device according to claim 3 is used as the motor drive device.

9. An analogue electronic timepiece comprising:
a time hand stepping motor which rotates a time hand;
a chronograph hand stepping motor which rotates a chronograph hand; and
a motor drive device which drives each stepping motor, wherein
the motor drive device according to claim 4 is used as the motor drive device, the first stepping motor is used as the time hand stepping motor, and the second stepping motor is used as the chronograph hand stepping motor.

10. An analogue electronic timepiece comprising:
a time hand stepping motor which rotates a time hand;
a chronograph hand stepping motor which rotates a chronograph hand; and
a motor drive device which drives each stepping motor, wherein
the motor drive device according to claim 5 is used as the motor drive device, the first stepping motor is used as the time hand stepping motor, and the second stepping motor is used as the chronograph hand stepping motor.
